(19) United States
(12) Patent Application Publication
(10) Pub. No.: US 2024/0362400 A1
(43) Pub. Date: Oct. 31, 2024

(54) INFORMATION PROCESSING APPARATUS, CONTROL METHOD THEREOF, AND STORAGE MEDIUM

(71) Applicant: CANON KABUSHIKI KAISHA, Tokyo (JP)

(72) Inventor: TAKUYA INOUE, Ibaraki (JP)

(21) Appl. No.: 18/639,666

(22) Filed: Apr. 18, 2024

(30) Foreign Application Priority Data
Apr. 26, 2023 (JP) 2023-072669

(51) Int. Cl. G06F 40/109; G06F 40/137; G06T 11/20

(52) U.S. Cl. CPC G06F 40/109; G06F 40/137; G06T 11/203

(57) ABSTRACT

An information processing apparatus input a document represented by hierarchical structure including a plurality of drawing commands; analyze each of the plurality of drawing commands of respective hierarchical levels corresponding to from a rearmost side to a frontmost side in the document, starting from the rearmost side; determine whether or not the drawing command being analyzed is a command for drawing a graphic object; generate a rendered image of the graphic object by rendering the graphic object in a case where the determining determines that the drawing command is a command to draw the graphic object; and perform character recognition processing on the rendered image.

### BACKGROUND OF THE INVENTION

### Field of the Invention

The present invention relates to an information processing apparatus, a control method thereof, and a storage medium.

### Description of the Related Art

Since online document management systems are widely used, a larger number of users are storing documents online. In order to support browsing and searching documents stored in such a manner, it is desired to recognize characters included in documents to enable text search, text selection and copying, reading text aloud, or the like. For example, text objects can be directly acquired from the document structure of such documents as those created using Microsoft Word® or PowerPoint®. Therefore, text search, text selection and copying, reading text aloud, or the like can be easily performed with such documents. However, a document in which entire page of the document is converted into an image using a scanner or the like (referred to as a full-page image document in the following description), or a document in which text characters are converted into graphic outline font characters (referred to as an outline-font-character document in the following description) do not include information related to text objects. Therefore, text objects need to be recognized first in order to enable text search, text selection and copying, reading text aloud, or the like to be performed on full-page image documents or outline-font-character documents.

Japanese Patent Laid-Open No. 2020-102148 discloses an Optical Character Recognition (OCR) method for reading a document and recognizing characters in the document.

In the aforementioned method, the premise is that a document is a full-page image. And therefore, an outline-font-character document is also needed to be converted to the full-page image to perform OCR processing. However, there is a problem that the accuracy of character recognition by the OCR processing may decrease when a character to be recognized is represented in an intermediate color or located on another image.

### SUMMARY OF THE INVENTION

The present invention enables realization of an improved character recognition accuracy of a document represented by hierarchical structure including a plurality of drawing commands.

One aspect of the present invention provides an information processing apparatus comprising: one or more memory devices that store a set of instructions; and one or more processors that execute the set of instructions to: input a document represented by hierarchical structure including a plurality of drawing commands; analyze each of the plurality of drawing commands of respective hierarchical levels corresponding to from a rearmost side to a frontmost side in the document, starting from the rearmost side; determine whether or not the drawing command being analyzed is a command for drawing a graphic object; generate a rendered image of the graphic object by rendering the graphic object in a case where the determining determines that the drawing command is a command to draw the graphic object; and perform character recognition processing on the rendered image.

Another aspect of the present invention provides a control method for controlling an information processing apparatus comprising: inputting a document represented by hierarchical structure including a plurality of drawing commands; analyzing each of the plurality of drawing commands of respective hierarchical levels corresponding to from a rearmost side to a frontmost side in the document, starting from the rearmost side; determining whether or not the drawing command being analyzed is a command for drawing a graphic object; generating a rendered image of the graphic object by rendering the graphic object in a case where the determining determines that the drawing command is a command for drawing a graphic object; and performing character recognition processing on the rendered image.

Still another aspect of the present invention provides a non-transitory computer readable medium comprising instructions, when executed by a computer system, cause the computer system to: input a document represented by hierarchical structure including a plurality of drawing commands; analyze each of the plurality of drawing commands of respective hierarchical levels corresponding to from a rearmost side to a frontmost side in the document, starting from the rearmost side; determine whether or not the drawing command being analyzed is a command for drawing a graphic object; generate a rendered image of the graphic object by rendering the graphic object in a case where the determining determines that the drawing command is a command for drawing a graphic object; and perform character recognition processing on the rendered image.

Further features of the present invention will be apparent from the following description of exemplary embodiments with reference to the attached drawings.

### BRIEF DESCRIPTION OF THE DRAWINGS

FIG. 1 is a block diagram illustrating an example of a hardware configuration of an information processing apparatus according to an embodiment of the present invention;

FIG. 2 is a functional block diagram illustrating an example of a software configuration of the information processing apparatus;

FIG. 3A is a diagram illustrating an example of commands for certain page information in an outline-font-character document;

FIG. 3B is a diagram illustrating an image corresponding to the commands as a plan;

FIG. 3C is a diagram illustrating an image corresponding to the commands as hierarchical structure;

FIG. 4 is a flowchart illustrating character recognition, of a certain page of an outline-font-character document, performed by the information processing apparatus according to the embodiment;

FIG. 5 is a diagram illustrating an example of a rendered image in which a graphic object of the page information of FIG. 3A is rendered in a state independent of the hierarchical structure;

FIG. 6 is a diagram illustrating an example of a document including an OCR result according to the embodiment; and

FIG. 7 is a diagram illustrating an example of a full-page image in which characters “1234” are drawn in red color on a background of orange color.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

An information processing apparatus is described as an example of an embodiment, which performs OCR processing after converting a graphic object made independent from the hierarchical structure to an image, when the OCR processing is performed to an outline-font-character document represented by hierarchical structure including a plurality of drawing commands.

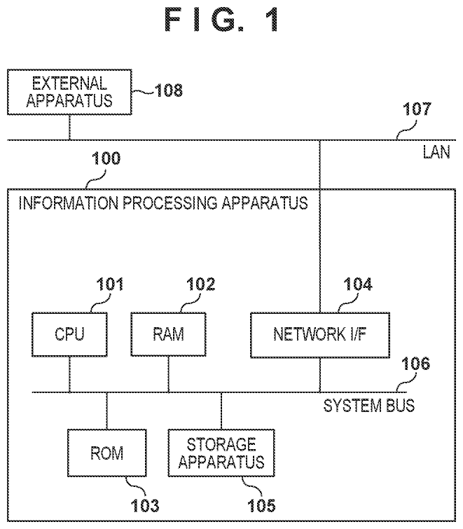

FIG. 1 is a block diagram illustrating an example of a hardware configuration of the information processing apparatus 100 according to an embodiment of the present invention.

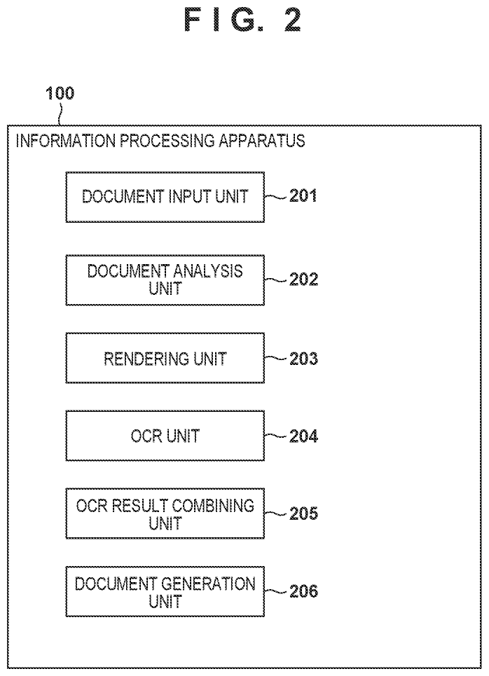

The information processing apparatus 100 includes a CPU 101, a RAM 102, a ROM 103, a network interface (I/F) 104, and a storage apparatus 105, which are connected to each other via a system bus 106. The CPU 101 is the control center of the information processing apparatus 100. The RAM 102 is a storage device accessible from the CPU 101, and used as a work memory for operation of the CPU 101 in the present embodiment. Programs are stored in the ROM 103, and each of the software modules illustrated in FIG. 2 described below operate by the CPU 101 deploying the programs on the RAM 102 and executing. A network I/F 104 is a N interface which is connected to an external apparatus 108 (such as a server or other apparatuses) via a network 107 and serves for inputting and outputting information. The storage apparatus 105 is an auxiliary storage apparatus such as an HDD or an SSD, and is used as a work area of the CPU 101 or used for storing data such as a document. Here, in the embodiment, it is assumed to acquire a document from the external apparatus 108 via the network I/F 104 or acquire a document from the storage apparatus 105.

FIG. 2 is a functional block diagram illustrating an example of a software configuration of the information processing apparatus 100. The information processing apparatus 100 includes software modules 201 to 206 illustrated in FIG. 2. As has been described above, the software modules operate by the CPU 101 executing the programs deployed from the ROM 103 to the RAM 102.

A graphic object is acquired from a drawing command in a document by a document analysis unit 202 analyzing the document input by a document input unit 201. A rendering unit 203 performs rendering processing to deploy the acquired graphic object into a bitmap image of a specified resolution. An OCR unit 204 executes OCR processing on an image acquired by rendering. An OCR result combining unit 205 combines a character code and character position information acquired by the OCR unit 204. A document generation unit 206 adds the combined character code and character position information to the original document to generate a document including the OCR result.

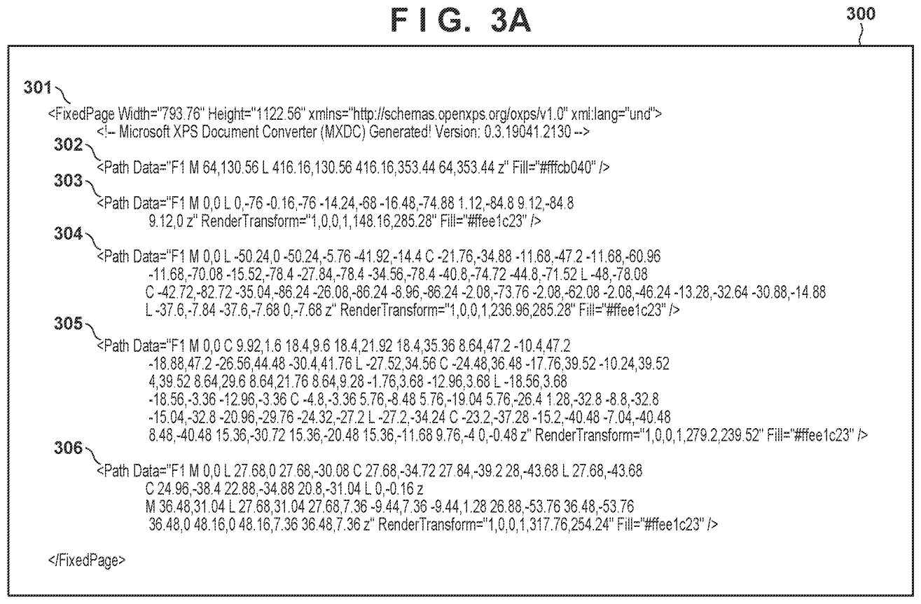

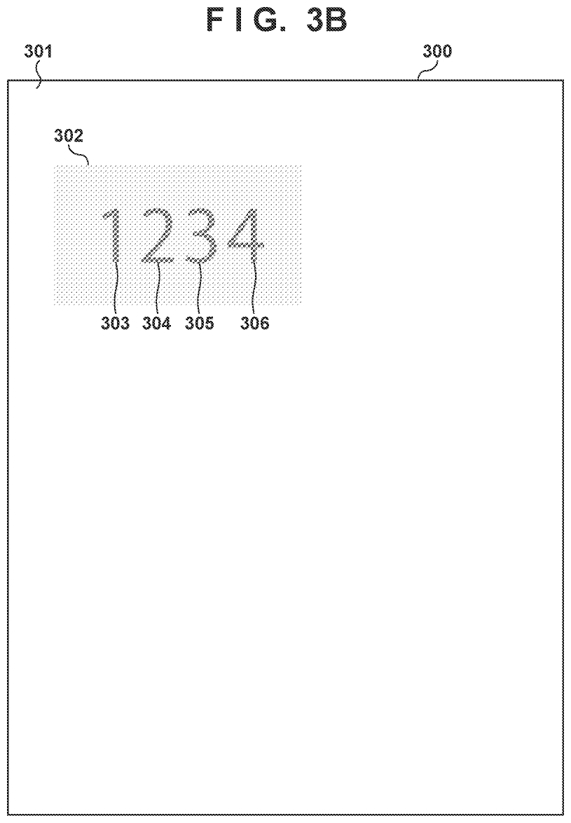

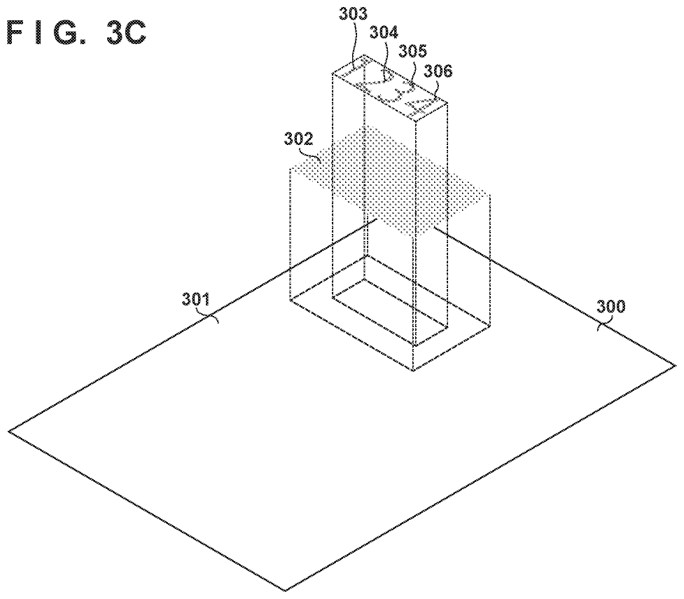

FIG. 3A to FIG. 3C are explanatory diagrams of a structure of an outline-font-character document according to the embodiment. Although description here is provided taking simple XPS data as an example, the data format to be handled is not limited to XPS data and may be another data format such as PDF data.

Page information of a document includes a command related to the width and the height of the page, a command related to drawing, or the like. In addition, the drawing commands exist independently of each other, and drawing is performed from the rearmost side to the frontmost side in the order the commands are read. Accordingly, hierarchical structure of the drawing commands is structured such that a drawing command read later is drawn on the front side when the coordinates are overlapped. Furthermore, an outline-font-character document does not include information related to a text object such as a font and a character code, because a command for drawing a character in the outline-font-character document draws the character as a graphic object specified by points and lines connecting the points.

FIG. 3A is a diagram illustrating an example of commands for certain page information 300 in an outline-font-character document. FIG. 3B is a diagram illustrating an image corresponding to the commands as a plan, and FIG. 3C is a diagram illustrating an image corresponding to the commands as hierarchical structure. Here, drawing commands are arranged in the order from the rearmost side to the frontmost side. A “FixedPage” command in a command 301 is a command related to the width and the height of the page, and “Width=“793.76”” is indicating the width of the page and “Height=“1122.56”” is indicating the height of the page. Each “Path Data” in command 302 to command 306 indicates a drawing command of a graphic object.

In “Path Data”, “F” indicates a painting rule in which F0 indicates EvenOdd and F1 indicates NonZero, “M x, y” indicates a start point (x, y), and “L x1, y1 (x2, y2, . . . )” indicates a point sequence connecting to an immediately preceding point by a straight line. “C x1, y1 (x2, y2, . . . )” indicates a point sequence connecting to an immediately preceding point by a Bezier curve, and “z” connects an immediately preceding point and a start point. “RenderTransform” indicates an affine transformation matrix, “Fill” indicates a color for filling the inside of a graphic, and “#aarrggbb” indicates that R=0xrr, G=0xgg, B=0xbb, and α=0xaa.

“Path Data” in the command 302 is a drawing command of a graphic object read first, by which an orange rectangle of R=0xFF, G=0xFC, B=0xBO, and α=0xFF is drawn on the rearmost side (indicated by a reference numeral 302 in FIG. 3B and FIG. 3C).

“Path Data” in the command 303 is a drawing command of a graphic object, by which a character “1” is drawn as a graphic in red color with R=0xEE, G=0x1C, B=0x23, and α=0xFF on a rectangular object drawn by the command 302 (indicated by a reference numeral 303 in FIG. 3B and FIG. 3C). Similarly, each “Path Data” in the command 304 to command 306 is a drawing command of a graphic object, by which characters “2”, “3”, and “4” are drawn as graphics on the rectangular object drawn by the command 302 (indicated by reference numerals 304, 305 and 306 in FIG. 3B and FIG. 3C).

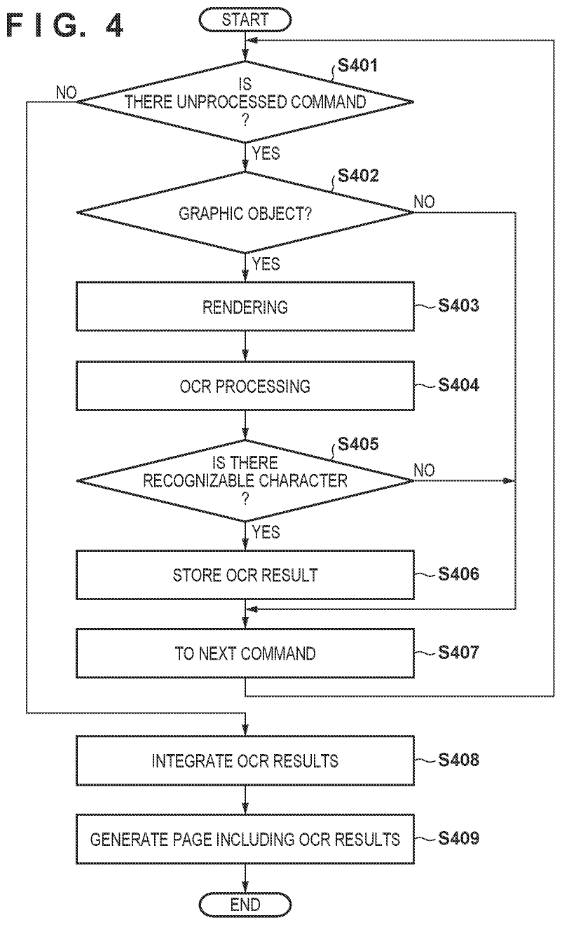

FIG. 4 is a flowchart for explaining character recognition of a certain page of an outline-font-character document, performed by the information processing apparatus 100 according to the embodiment. The processing is executed on each page of a document acquired, by the document input unit 201, from the external apparatus 108 via the network I/F 104, or from the storage apparatus 105. Explanation of FIG. 4 is described by using the page information 300 of the outline-font-character document illustrated in FIG. 3A. In addition, the document mentioned here refers to a document represented by hierarchical structure including a plurality of drawing commands. Note that, the processing illustrated in the flowchart of FIG. 4 is realized by the CPU 101 executing the program deployed in the RAM 102 as described above.

When functioning as the document analysis unit 202, the CPU 101 sequentially analyzes the drawing commands from the rearmost side to the frontmost side, starting from the rearmost side, in the document represented by the hierarchical structure. The CPU 101 functions as the document analysis unit 202 at S401, and determines whether or not an unprocessed command to be read is present in the page information. When an unprocessed command is determined to be present, the CPU 101 advances the processing to S402, or advances the processing to S408 when an unprocessed command is determined to be not present. The CPU 101 functions as a document analysis unit 202 at S402, and determines whether or not a command of a certain hierarchical level being read is a drawing command and corresponds to a graphic object. When it is determined that the command corresponds to a graphic object, the CPU 101 advances the processing to S403, or advances the processing to S407 when it is determined that the command is another command.

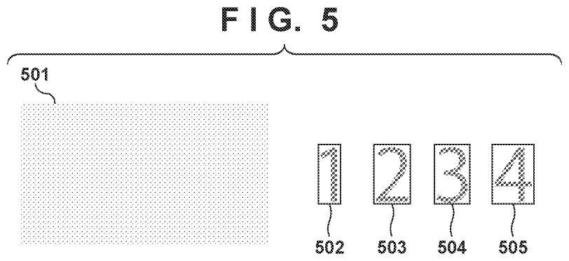

The CPU 101 functions as the rendering unit 203 at S403, and performs so-called rendering processing in which only the graphic object in the hierarchical level being acquired is developed to a bitmap image of a specified certain resolution. In the page information 300 of FIG. 3A, command 302 to command 306 correspond to graphic objects. Each graphic object is then rendered in a state independent of the hierarchical structure to generate graphic object images 501 to 505 independent of the hierarchical structure and not including the rear side, as illustrated in FIG. 5.

FIG. 5 is a diagram illustrating an example of a rendered image in which a graphic object of the page information 300 of FIG. 3A is rendered in a state independent of the hierarchical structure.

Next, the processing proceeds to S404, and the CPU 101 functions as the OCR unit 204 and executes OCR processing on the rendered images 501 to 505 of respective graphic objects. Next, the processing proceeds to S405, and the CPU 101 functions as the OCR unit 204 and determines whether or not a character that corresponds with any character code is present among the characters subjected to character recognition, in other words, whether or not a character is recognized. When the character is recognized, the CPU 101 advances the processing to S406, or advances the processing to S407 when the character is not recognized. The CPU 101 functions as the OCR unit 204 at S406, and stores, in the storage apparatus 105 as an OCR result, the character code and character position information of the character being acquired and recognized by character recognition. The specific means of OCR processing is not different from conventional technology, and therefore description thereof is omitted. Next the processing proceeds to S407, and the CPU 101 functions as the document analysis unit 202 and reads the next command. As such, the processing from S402 to S407 are repeatedly performed until all the commands included in the page information are processed.

In the example illustrated in FIG. 5, for example, no character is present in the image 501 which corresponds with any character code, but in the images 502 to 505, characters are present which corresponds with some character code. Accordingly, character codes respectively corresponding to characters “1”, “2”, “3” and “4” and character position information respectively corresponding to each of the character codes are acquired at S404, and character codes and character position information of the characters recognized by character recognition at S406 are stored in association with each other.

When all the commands are processed as described above, then at S401, the processing proceeds to S408, and the CPU 101 functions as the OCR result combining unit 205, and combines the character codes and the character position information in the page acquired by the OCR unit 204. And then the processing proceeds to S409, and the CPU 101 functions as the document generation unit 206, and generates a page including the OCR result by adding the character codes and the character position information being combined in the page to the original document.

A document including the OCR result is generated by an execution of the foregoing processing on all the pages.

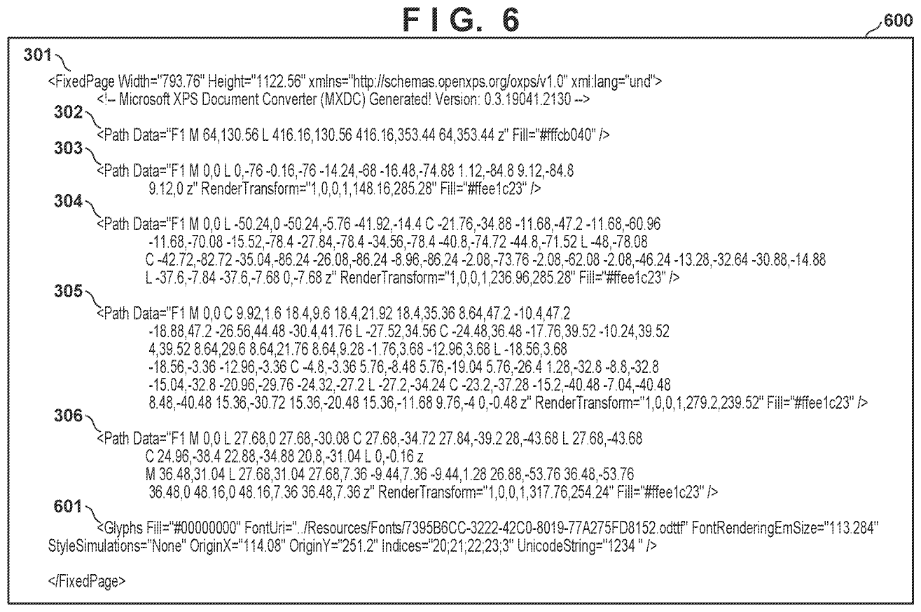

FIG. 6 is a diagram illustrating an example of a document including an OCR result according to the embodiment. In FIG. 6, parts common to those in FIG. 3 described above are provided with same reference numerals, and descriptions thereof will be omitted.

A document 600 is a document in which character codes and character position information being combined in the page are added to the page information 300 of the original document in FIG. 3A, and thus the command 301 to command 306 in the page information 300 of the original document remain unchanged. In FIG. 6, a command 601 indicating a character code and character position information is added after the command 306.

“Glyphs” in the command 601 indicates a drawing command of a text object. “FontUri” in the command 601 indicates a storage location of a font to be referred, and “FontRenderingEmSize” indicates a font size. “StyleSimulations” indicates information related to a character shape such as bold or italic. “OriginX” indicates an X-coordinate of the start point, “OriginY” indicates a Y-coordinate of the start point, and “Indices” indicates information for specifying an optional parameter which is not essential, such as an index of actual font data corresponding to a character code. “UnicodeString” indicates a text to be drawn.

“Glyphs” in the command 601 draws a completely transparent character string “1234” to overlap the characters drawn as graphic by the command 303 to command 306 included in the page information 300 of the original document. Seemingly, a completely transparent character string is merely added by this command, the document however comes into a state in which the character information is added to the document, and text search (character search), text selection (character selection) and copying, reading text aloud, or the like are enabled.

According to the embodiment as has been described above, when an outline-font-character document is subjected to OCR, a graphic object independent of hierarchical structure is converted into an image and subsequently subjected to OCR, instead of converting the outline-font-character document into a full-page image and performing OCR.

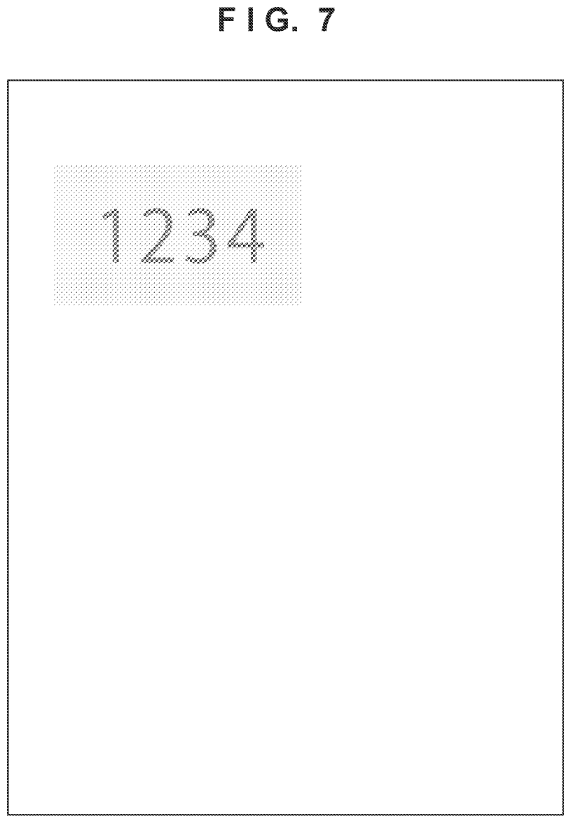

In the example of the page information 300 of the outline-font-character document of FIG. 3A, it is necessary to perform OCR on the image illustrated in FIG. 7 when OCR is performed on the entire image. In the example of FIG. 7, characters “1234” are drawn in red color against a background of orange color. In this case, it is necessary to perform character recognition by, for example, determining a threshold value to successfully separate the rectangular image of orange color and the characters of red color from each other. In such a case, character recognition may become more difficult when characters are located on a more complex image.

In contrast, in the embodiment, a graphic object independent of the hierarchical structure is extracted and converted into an image to perform character recognition, and thus character recognition processing can be performed without being obstructed by other objects. Accordingly, it is possible to improve the character recognition accuracy of an outline-font-character document.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-072669, filed Apr. 26, 2023 which is hereby incorporated by reference herein in its entirety.

What is claimed is:

1. An information processing apparatus comprising:
one or more memory devices that store a set of instructions; and
one or more processors that execute the set of instructions to:
input a document represented by hierarchical structure including a plurality of drawing commands;
analyze each of the plurality of drawing commands of respective hierarchical levels corresponding to from a rearmost side to a frontmost side in the document, starting from the rearmost side;
determine whether or not the drawing command being analyzed is a command for drawing a graphic object;
generate a rendered image of the graphic object by rendering the graphic object in a case where the determining determines that the drawing command is a command to draw the graphic object; and
perform character recognition processing on the rendered image.

2. The information processing apparatus according to claim 1, wherein drawing commands are arranged in the document in an order from a drawing command of a rearmost side to a drawing command of a frontmost side.

3. The information processing apparatus according to claim 1, wherein the determining determines that the drawing command is a command for drawing a graphic object in a case where the drawing command includes a command indicating an image specified by a point and a line.

4. The information processing apparatus according to claim 1, wherein the rendered image is a bitmap image of a certain resolution.

5. The information processing apparatus according to claim 1, wherein
the one or more processors execute instructions in the one or more memory devices to:
acquire a character code of a character being recognized and position information indicating a position of the character.

6. The information processing apparatus according to claim 5, wherein the one or more processors execute instructions in the one or more memory devices to:
add the character code being acquired and the position information of the character to the document.

7. The information processing apparatus according to claim 1, wherein
the document includes outline font characters which are text characters converted into graphic outline font characters.

8. A control method for controlling an information processing apparatus comprising:
inputting a document represented by hierarchical structure including a plurality of drawing commands;
analyzing each of the plurality of drawing commands of respective hierarchical levels corresponding to from a rearmost side to a frontmost side in the document, starting from the rearmost side;
determining whether or not the drawing command being analyzed is a command for drawing a graphic object;
generating a rendered image of the graphic object by rendering the graphic object in a case where the determining determines that the drawing command is a command for drawing a graphic object; and
performing character recognition processing on the rendered image.

9. A non-transitory computer readable storage medium comprising instructions, when executed by a computer system, cause the computer system to:
input a document represented by hierarchical structure including a plurality of drawing commands;
analyze each of the plurality of drawing commands of respective hierarchical levels corresponding to from a rearmost side to a frontmost side in the document, starting from the rearmost side;
determine whether or not the drawing command being analyzed is a command for drawing a graphic object;
generate a rendered image of the graphic object by rendering the graphic object in a case where the determining determines that the drawing command is a command for drawing a graphic object; and
perform character recognition processing on the rendered image.
